(19) United States
(12) Patent Application Publication
(10) Pub. No.: US 2026/0238332 A1
(43) Pub. Date: Aug. 13, 2026

(54) METHODS FOR REDUCING BEAM SWEEPING TIME FOR A USER EQUIPMENT

(71) Applicant: Apple Inc., Cupertino, CA (US)

(72) Inventors: Jie Cui, San Jose, CA (US); Haitong Sun, Cupertino, CA (US); Yang Tang, San Jose, CA (US); Chunxuan Ye, San Diego, CA (US); Qiming Li, Beijing (CN); Dawei Zhang, Saratoga, CA (US); Hong He, San Jose, CA (US); Xiang Chen, Palo Alto, CA (US); Konstantinos Sarrigeorgidis, Los Gatos, CA (US); Yuexia Song, Beijing (CN)

(21) Appl. No.: 19/155,896

(22) PCT Filed: Feb. 13, 2023
(86) PCT No.: PCT/CN2023/075647

§ 371 Date: Aug. 12, 2025

(51) Int. Cl. H04B 7/185; H04B 7/06; H04B 7/195

(52) U.S. Cl. CPC H04B 7/18519; H04B 7/06962; H04B 7/18508; H04B 7/195

(57) ABSTRACT

A user equipment (UE) including a transceiver and a processor is disclosed. The processor is configured to: receive a beam measurement configuration for performing beam measurements on a first set of beams of a first network access point and a second set of beams of a second network access point; receive ephemeris information including first ephemeris information corresponding to the first network access point and second ephemeris information corresponding to the second network access point; identify a reception (Rx) beam of the first set of beams as a reference beam in accordance with beam measurements performed for the first set of beams; based on the reference beam, and based on the first ephemeris information or the second ephemeris information, identify one or more target Rx beams; and report, to the network, the one or more target Rx beams to receive downlink information via the second network access point.

### TECHNICAL FIELD

This application relates generally to wireless communication systems, including methods and implementations of reducing a beam sweeping time for a user equipment (UE) with regards to network devices (e.g., network access points) deployed in a non-terrestrial network (NTN).

### BACKGROUND

Wireless mobile communication technology uses various standards and protocols to transmit data between a network device (e.g., a base station, a network access point, or a relay) and a wireless communication device (e.g., a user equipment (UE)). Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device (e.g., a base station, a network access point, or a relay) of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station, a network access point, or a relay) used by a RAN may correspond to that RAN. One example of the network device may be an E-UTRAN base station, which is an Evolved Universal Terrestrial Radio Access Network (E-UTRAN) Node B (also commonly denoted as evolved Node B, enhanced Node B, eNodeB, or eNB). Another example of the network device may be an NG-RAN base station, which is a next generation Node B (also sometimes referred to as a gNode B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a communication system including a UE and a network device deployed in an NTN.

FIG. 2 shows an example diagram that illustrates a reduction in beam sweeping time, or layer-3 (L3) measurement enhancements, based on beam tracking for a number of satellites in a neighboring cell, and based on a reference reception (Rx) beam and ephemeris information, as described herein in accordance with some embodiments.

FIG. 3 shows an example diagram that illustrates a reduction in beam sweeping time, or layer-3 (L3) measurement enhancements, based on beam tracking for a number of satellites in a neighboring cell, and based on previously performed measurements for a serving cell network device and ephemeris information, as described herein in accordance with some embodiments.

FIG. 4 shows an example diagram that illustrates a reduction in beam sweeping time, or layer-3 (L3) measurement enhancements, based on a subset of Rx beams and to reduce a beam sweeping factor, as described herein in accordance with some embodiments.

FIG. 5 shows an example method of wireless communication by a UE, which method may be used for reducing beam sweeping time, or for layer-3 (L3) measurement enhancements, as described herein in accordance with some embodiments.

FIG. 6 shows another example method of wireless communication by a UE, which method may be used for reducing beam sweeping time, or for layer-3 (L3) measurement enhancements, as described herein in accordance with some embodiments.

FIG. 7 shows an example method of wireless communication by a network device, which method may be used for reducing beam sweeping time, or for layer-3 (L3) measurement enhancements, as described herein in accordance with some embodiments.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device. Similarly, various embodiments are described with regard to a network device, which may be a network access point (e.g., a base station or a relay) deployed in a satellite or a high-altitude platform system (HAPS) (e.g., a manned or unmanned aerial vehicles) in a terrestrial network (TN) or an NTN. A network device deployed in a satellite or a HAPS may be referred to herein as an NTN device, and accordingly, a network device deployed in a satellite and/or a HAPS may be said to be deployed in an NTN. The satellites or HAPS may be orbiting in a geo synchronous orbit (GSO) and/or a non geo synchronous orbit (N-GSO) in a non-terrestrial network (NTN). The below description often refers to a satellite or satellites, but some or all of the satellite(s) mentioned in the below description may alternatively be HAPS.

In a scalable multiple-input and multiple-output (MIMO) wireless communication system, a 3GPP network (hereafter referred to as “network”) may transmit different downlink signals, at different times, using different numbers of antenna ports. The number of antenna ports used to transmit a particular downlink signal may be based on factors such as dynamic point(s) selection (e.g., transmission and reception point (TRP) selection), interference management, and network power saving considerations. As an example, a network device, which may be a network access point or a base station in a TN, a satellite, or a HAPS may transmit downlink (DL) information using a particular antenna beam of the network device to a particular antenna beam of a UE. The particular antenna beam of the UE may be referenced in this disclosure as a reception (Rx) beam of the UE. The Rx beam may be identified by the UE based on layer-3 measurements performed by the UE.

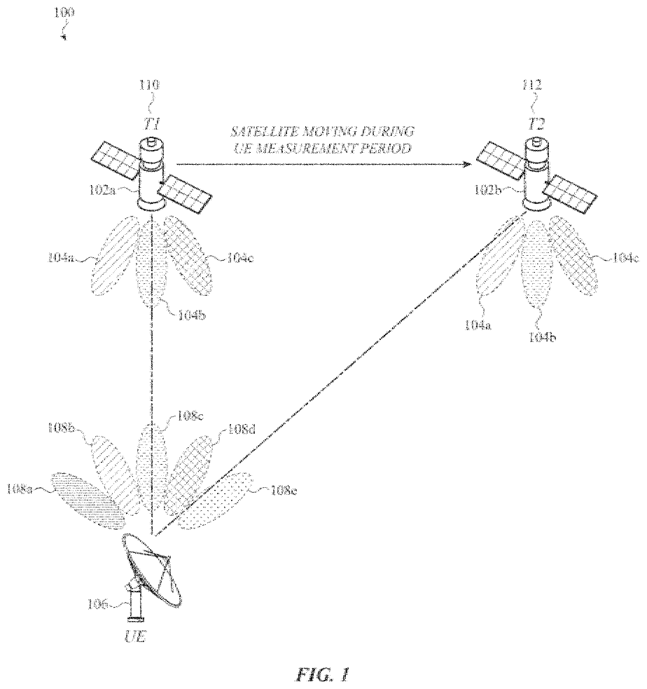

The UE may be mobile, and accordingly a Rx beam of the UE may change over time. In some embodiments, the network device may be deployed in a satellite, or in a HAPS in a TN or an NTN. The network device deployed in a satellite, or a HAPS in an NTN may be orbiting in a GSO or an N-GSO. The network device in the NTN, and in particularly in the N-GSO, may change its position with respect to the UE at a very high rate. In other words, a Rx beam of the UE that is used to receive DL information from the network device may change very frequently. The Rx beam of the UE that is used to receive DL information from the network device may be identified using beam sweeping techniques, and in accordance with L3 measurements performed by the UE. Since the network device is moving very fast compared to the UE, a Rx beam identified using currently known beam sweeping techniques, and in accordance with L3 measurements performed by the UE, may not be a valid Rx beam or an ideal Rx beam. This particular scenario is described using FIG. 1 below.

FIG. 1 shows a communication system including a UE and a network device deployed in an NTN. By way of example, only one network device is shown in FIG. 1. As shown in FIG. 1, a communication system 100 may include a UE 106 having multiple antenna beams 108a-108econnected to a network device, which may be a base station, a network access point, or a relay deployed in a satellite, or a HAPS in an NTN as shown in FIG. 1. At a time T1 110, the satellite may be at a first position, which is shown as 102a in FIG. 1, and an antenna beam 104b of antenna beams 104a-104c of the network device may be an ideal beam to transmit DL information to an antenna beam 108c of the UE. The antenna beam 108c of the UE may be an ideal Rx beam for the UE. Thus, the antenna beam pair 108c and 104b may be used for transmitting DL information to the UE 106 at the time T1 110. However, since the satellite is moving at a very fast rate compared to the UE 106, at a time T2 112, the satellite may be at a second position, which is shown as 102b in FIG. 1. At the second position 102b, the beam pair 104b and 108c is no longer an ideal beam pair for DL information transmission. The ideal beam pair, at the time T2 112, may be 104a and 108e, as shown in FIG. 1. Accordingly, by the time, the UE may perform various L3 measurements, and report the ideal beam pair to a network, the ideal beam pair may no longer be an ideal beam pair for DL information transmission.

In other words, the legacy beam sweeping techniques may not be able to track the DL signal in a timely fashion. For example, a UE with a beam sweeping factor of 8 and an SSB periodicity of 160 ms, may only have 1280 ms, times a sharing factor, to perform beam tracking using a synchronization signal block (SSB). The sharing factor may be based on measurement resource sharing with other UE activities, including but not limited to, L1 UE behavior or activities such as an uplink (UL) and/or DL transmission, or measurement gap on different carriers, and so on. Accordingly, a value of the sharing factor may be less than 1.

In the current radio resource measurement (RRM) specification, no beam forming requirements or beam sweeping requirements are described for a network device that is, in particular, deployed in an NTN for RRM Layer-3 (L3) or RRM Layer-1 (L1) measurements, a beam failure detection (BFD), a candidate beam detection (CBD), L3 reference signal received power (RSRP) measurements, and/or transmission configuration indicator (TCI) switching, radio link monitoring (RLM), and so on. Further, the RRM requirements for a frequency band that is above 10 GHz, such as a Ka band, and used for communication with a satellite in an NTN differ from a network device operating in frequency range 1 (FR1).

Various embodiments described herein provide solutions for L3 measurement enhancement for a network device that is deployed in an NTN, for example, in a satellite orbiting in an N-GSO, and/or for the Ka frequency band that is above 10 GHz.

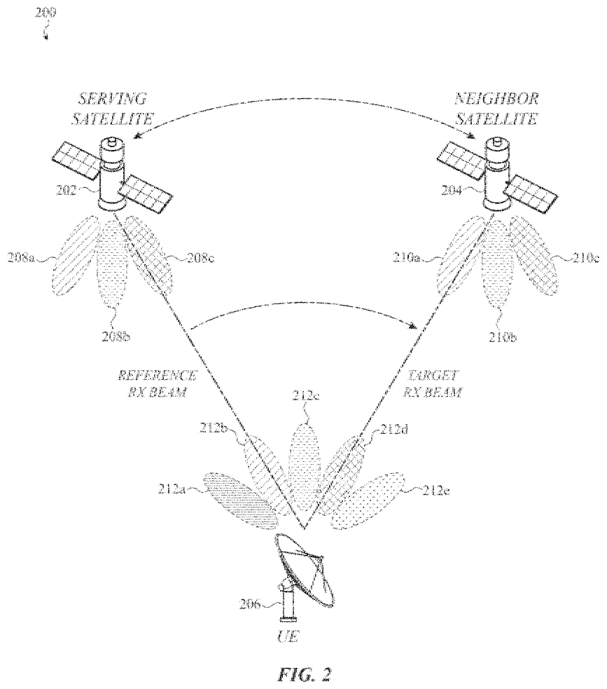

FIG. 2 shows an example diagram that illustrates a reduction in beam sweeping time, or layer-3 (L3) measurement enhancements, based on beam tracking for a number of satellites in a neighboring cell, and based on a reference reception (Rx) beam and ephemeris information, as described herein in accordance with some embodiments. In particular, embodiments described herein using FIG. 2 correspond with reducing L3 measurement time for a UE that is connected with a number of network access points (or network devices), which network devices may include a base station, a network access point, or a relay, deployed in a satellite, or a HAPS in a TN or an NTN. The HAPS may include one or more drones, and manned or unmanned aerial vehicles. The HAPS or satellites may be orbiting in N-GSO and may be moving at a comparatively faster speed than the UE. In some embodiments, beam tracking information for one or more network devices deployed in one or more neighboring cells for the UE is derived by the UE, or provided to the UE, based on a current serving cell in which a network device is located and providing services to the UE.

As shown in a wireless communication system 200, a UE 206 may be served by a network device deployed in a first satellite shown as 202, at a time T1. The UE 206 may have multiple antenna beams, e.g., antenna beams 212a-212e, and the network device deployed in the first satellite 202 may also have multiple antenna beams, e.g., antenna beams 208a-208c. The network device deployed in the first satellite 202 may be providing services to the UE at the time T1. Accordingly, the first satellite 202 may be a serving satellite for the UE 206 at the time T1.

By way of a non-limiting example, the UE 206 may receive DL information from the first satellite 202 using antennas 212b and 208c, and the antenna pair 212b and 208c may be identified by the UE 206 based on various L3 measurements, including but not limited to, the strongest L3 measurements, such as RSRP measurements, reference signal received quality (RSRQ) measurements, and/or signal-to-interference-plus-noise ratio (SINR) measurements. A beam associated with the antenna pair 212b and 208c may be referred to as a reference Rx beam.

The UE 206 may receive DL information using the reference Rx beam. The reference Rx beam may be determined by the UE 206 based on a configuration received by the UE 206 from a network. The network may include a RAN, a core network, a TN, an NTN, and so on. Accordingly, the configuration received by the UE may include information regarding performing L3 measurements on various network devices of one or more neighboring cells for the UE 206.

By way of a non-limiting example, the configuration received by the UE may include ephemeris information corresponding to a network device in the serving cell of the UE, and/or ephemeris information corresponding to one or more satellites in one or more serving cells of the UE 206. The ephemeris information may include values corresponding to various parameters, such as elevation angle information for one or more satellites, orbiting speed of the one or more satellites, trajectory information of the one or more satellites, distance between various satellites, and so on.

One or more satellites in one or more neighboring cells may be identified based on the ephemeris information and the current position of the satellite of the serving cell of the UE 206. The current position of the satellite of the serving cell of the UE 206 may be determined based on the reference Rx beam.

Accordingly, in some embodiments, a target Rx beam, corresponding to a time T2, and associated with a second satellite 204 in a neighboring cell of the UE 206, may be identified or derived using various parameters and their values included in the ephemeris information. and in accordance with the reference Rx beam. For example, the target Rx beam may be identified as 210a of the three antenna beams 210a-210c of the second satellite 204.

In some embodiments, a network may indicate to the UE which one or more satellites may be in one or more neighboring cells of the UE 206 based on the serving satellite of the UE 206. By way of a non-limiting example, in some embodiments, the reference Rx beam may be determined based on the strongest L3 measurements, such as RSRP measurements, reference signal received quality (RSRQ) measurements, and/or signal-to-interference-plus-noise ratio (SINR) measurements performed with respect to a specific synchronization signal block (SSB) and/or a channel state information reference signal (CSI-RS) index. The UE 206 may identify a target Rx beam, corresponding to a time T2 and associated with the second satellite 204 in the neighboring cell of the UE 206, associated with a particular SSB and/or CSI-RS index of the target Rx beam of the second satellite 204 in the neighboring cell of the UE 206.

In some embodiments, and by way of a non-limiting example, the UE 206 may be provided information associating an SSB and/or a CSI-RS index of the reference Rx beam with an SSB and/or a CSI-RS index of the target Rx beam of one or more satellites in one or more neighboring cells of the UE 206. Accordingly, the reference Rx beam and/or the target Rx beam may be specific to a SSB and/or a reference signal (RS). The network may indicate to the UE 206 an association or a mapping between an RS of the reference Rx and a respective RS of one or more target Rx beams.

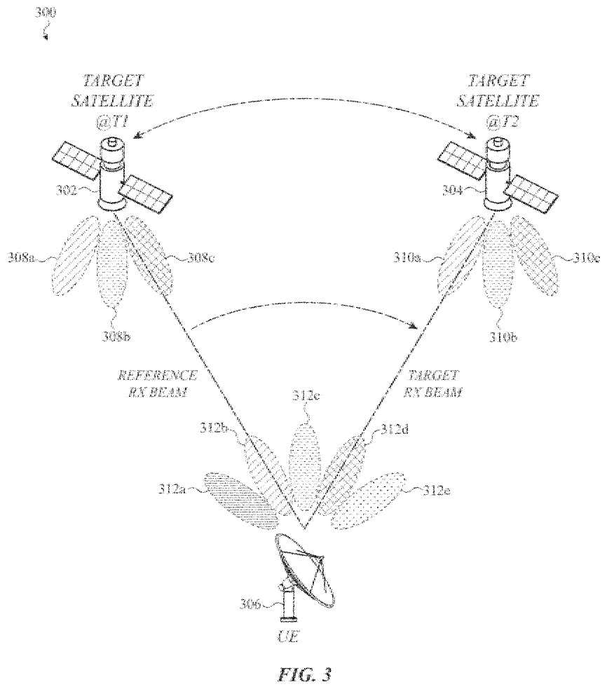

FIG. 3 shows an example diagram that illustrates a reduction in beam sweeping time, or layer-3 (L3) measurement enhancements, based on beam tracking for a number of satellites in a neighboring cell, and based on previously performed measurements for a serving cell network device and ephemeris information, as described herein in accordance with some embodiments. In particular, embodiments described herein using FIG. 3 correspond with reducing L3 measurements time for a UE that is connected with a number of network access points (or network devices. In some embodiments, beam tracking information for one or more network devices deployed in one or more neighboring cells for the UE is derived by the UE, or provided to the UE, based on the previously performed L3 measurements for a serving satellite, and/or one or more target satellites in one or more neighboring cells.

As shown in a wireless communication system 300, a UE 306 may be being served by a network device deployed in a first satellite shown as 302, at a time T1. In some embodiments, and by way of a non-limiting example, at the time T1, the first satellite 302 may be a first target satellite for the UE 306, and not a serving satellite for the UE 306. The UE 306 may have multiple antenna beams, e.g., antenna beams 312a-312e, and the network device deployed in the first satellite 302 may also have multiple antenna beams, e.g., antenna beams 308a-308c.

By way of a non-limiting example, the UE 306 may have identified that antenna beams 312b and 308c form an ideal Rx beam pair for receiving DL information at the time T1, as described herein in accordance with some embodiments. The antenna pair 312b and 308c may be identified by the UE 306 based on various L3 measurements, including but not limited to, the strongest L3 measurements, such as RSRP measurements, RSRQ measurements, and/or SINR measurements. A beam associated with the antenna pair 312b and 308c may therefore be a reference Rx beam corresponding to the time T1.

The reference Rx beam may be determined by the UE 306 based on a configuration received by the UE 306 from a network. The network, as described herein, may include a RAN, a core network, a TN, an NTN, and so on. Accordingly, the configuration received by the UE may include information regarding performing L3 measurements on various network devices of one or more neighboring cells for the UE 306.

By way of a non-limiting example, the configuration received by the UE may include ephemeris information corresponding to a network device in the serving cell of the UE, and/or ephemeris information corresponding to one or more satellites in one or more serving or neighboring cells of the UE 206. The ephemeris information may include values corresponding to various parameters, such as elevation angle information for one or more satellites, orbiting speed of the one or more satellites, trajectory information of the one or more satellites, distance between various satellites, and so on. One or more satellites in one or more neighboring cells may be identified based on differences in values corresponding to various parameters included in the ephemeris information for the time T1, which is the last time when the UE 306 performed L3 measurements, and for a time T2. The time T2 may be a current time or a future time, along with the reference Rx beam corresponding to the time T1. Accordingly, in some embodiments, a target Rx beam, corresponding to the time T2, and associated with a second satellite 304 in a neighboring cell of the UE 306 may be identified or derived using various parameters and their values included in the ephemeris information. and in accordance with the reference Rx beam.

In some embodiments, a network may indicate to the UE which one or more satellites may be in one or more neighboring cells of the UE 306 at time T2 based on the reference Rx beam corresponding to the time T1. The network may also indicate a threshold of a time difference between the time T2 and the time T1, for which the one or more satellites in the one or more neighboring cells of the UE 306 as indicated by the network may be valid. Accordingly, if the UE determines that a difference between the time T2 (or the current time) and the time T1 exceeds the threshold provided by the network, the UE may disregard the reference Rx beam for determining one or more target Rx beams. Further, the threshold value provided by the network may be a couple of seconds, or the threshold value may be determined based on a time period for which a transmit beam (Tx beam) of the satellite may be valid.

By way of a non-limiting example, in some embodiments, the reference Rx beam may be determined based on the strongest L3 measurements, such as RSRP measurements, RSRQ measurements, and/or SINR measurements performed with respect to a specific synchronization signal block (SSB) and/or a channel state information reference signal (CSI-RS) index. The UE 306 may identify a target Rx beam, corresponding to the time T2 and associated with the second satellite 304 in the neighboring cell of the UE 306, associated with a particular SSB and/or CSI-RS index of the target Rx beam of the second satellite 304 in the neighboring cell of the UE 306.

In some embodiments, and by way of a non-limiting example, the UE 306 may be provided information associating an SSB and/or a CSI-RS index of the reference Rx beam with an SSB and/or a CSI-RS index of the target Rx beam of one or more satellites in one or more neighboring cells of the UE 306. Accordingly, an SSB of the reference Rx beam may be SSB #1, and a corresponding SSB of the target Rx beam may be SSB #1 or SSB #2, etc. Accordingly, the reference Rx beam and/or the target Rx beam may be specific to an SSB and/or a reference signal (RS). The network may indicate to the UE 306 an association or a mapping between an RS of the reference Rx and a respective RS of one or more target Rx beams.

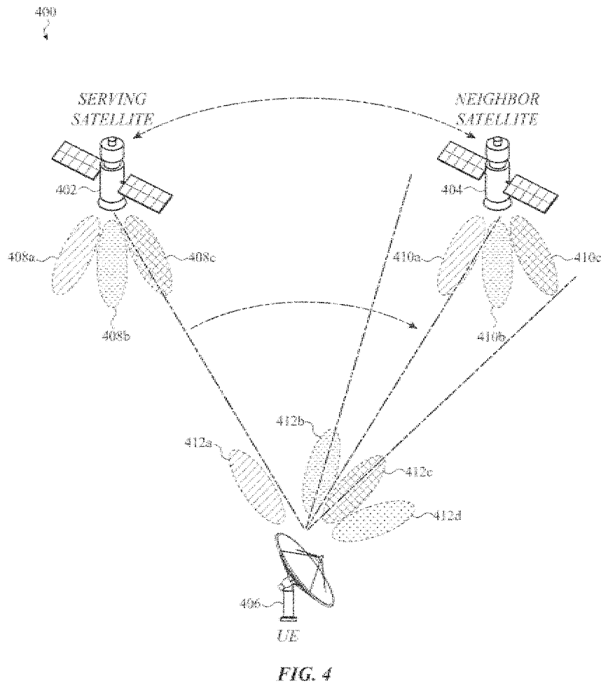

FIG. 4 shows an example diagram that illustrates a reduction in beam sweeping time, or layer-3 (L3) measurement enhancements, based on a subset of Rx beams and to reduce a beam sweeping factor, as described herein in accordance with some embodiments. As shown in a wireless communication system 400, a UE 406 may be being served by a network device deployed in a first satellite shown as 402, at a time T1, and by a second satellite shown as 404 at a time T2.

Accordingly, the satellite 402 may be a serving satellite or a first target satellite corresponding to the time T1, and the satellite 404 may be a second target satellite corresponding to the time T2.

Further, as shown in FIG. 4, the first satellite 402 may have multiple beams 408a-408c, and the second satellite 404 may have multiple beams 410a-410c. The UE 406 may have multiple beams 412a-412d. Even though, only three beams are shown here for the UE 406, the first satellite 402, and/or the second satellite 404, there may be more or less than three antenna beams at the UE 406, the first satellite 402, and/or the second satellite 404. By way of a non-limiting example, a maximum number of antenna beams at the UE 406, the first satellite 402, and/or the second satellite 404 may be eight. In other words, a beam sweeping factor (or Rx beam sweeping factor) may be eight for the UE 406, the first satellite 402, and/or the second satellite 404 having eight antenna beams. The UE 406 may accordingly need to perform L3 measurements for all eight antenna beams to determine a reference Rx beam and/or a target Rx beam.

In some embodiments, the beam sweeping time may be reduced by performing L3measurements or beam sweeping procedures for a lesser number of the antenna beams. For example, the L3 measurements or beam sweeping may be performed for a subset of antenna beams (3 antenna beams of a total eight antenna beams of a satellite). Additionally, or alternatively, a subset of target Rx beams may be formed including multiple antenna beam pairs between antenna beams of the UE and the satellite. The subset of target Rx beams may include antenna beams of the UE and/or antenna beams of the satellite which are consecutive antenna beams. The UE may report the subset size as a UE capability to a network, and the network may provide information regarding SSB, RS, and/or CSI-RS for a number of beams based on the subset size.

While various methods for reducing beam sweeping time or reducing L3 measurements time are described in various embodiments, a person skilled in the art may combine methods of different embodiments to further reduce beam sweeping time or L3 measurements time. Further, even though in various embodiments a network device is described as being deployed in a satellite, disclosure made herein does not limit the scope of an embodiment to a network device deployed in a satellite, rather the disclosure is applicable to a network device deployed in a TN, and/or a HAPS as well.

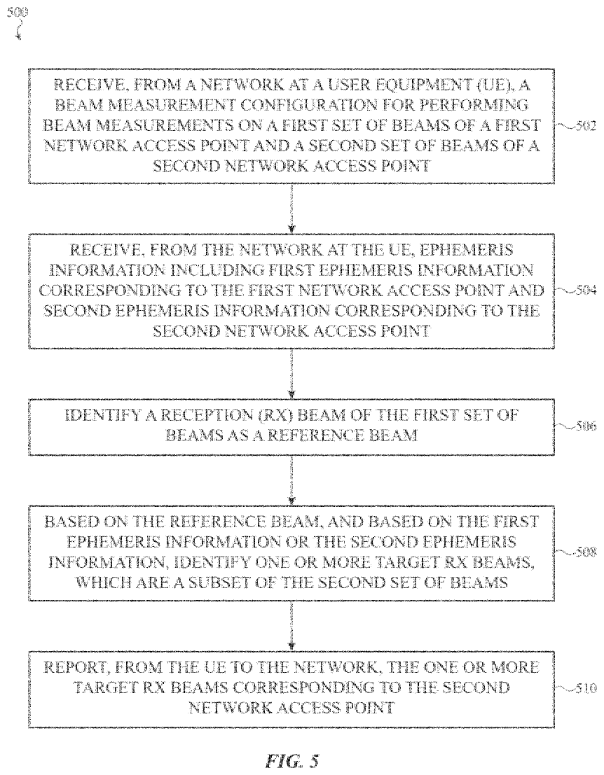

FIG. 5 shows an example method of wireless communication by a UE, which method may be used for reducing beam sweeping time, or for layer-3 (L3) measurement enhancements, as described herein in accordance with some embodiments. As shown in a flow-chart 500, at 502, a UE may receive from a network a beam measurement configuration for performing beam measurements on a first set of (antenna) beams of a first network device and a second set of (antenna) beams of a second network device. As described herein, the first network device and/or the second network device may be a network access point, a base station, a relay, a gNodeB, an eNodeB, a gNB, or an eNB, and so on. Further the first network device and/or the second network device may be deployed in a satellite, and/or a HAPS in a TN or an NTN. A network device deployed in the HAPS may be deployed in a manned or unmanned aerial vehicle, a drone, and so on. The HAPS in an NTN and/or the satellite may be orbiting in a GSO or an N-GSO. The beam measurement configuration may indicate an SSB and/or a CSI-RS index to be used for performing a beam sweeping procedure or L3 measurements with respect to one or more beams of the first network device and/or the second network device. As described herein, the beam measurement configuration may include an association and/or a mapping of an SSB index for one or more antenna beams of the first network device with an SSB index for one or more antenna beams of the second network device. Similarly, the beam measurement configuration may further include an association and/or a mapping of a CSI-RS index or RS for one or more antenna beams of the first network device with a CSI-RS index or RS for one or more antenna beams of the second network device.

At 504, the UE may receive from the network ephemeris information including values corresponding to various parameters, such as elevation angle information for one or more satellites, orbiting speed of the one or more satellites, trajectory information of the one or more satellites, distance between various satellites, and so on. The ephemeris information may accordingly include a first set of ephemeris information corresponding to the first network device, and a second set of ephemeris information corresponding to the second network device.

At 506, the UE may perform beam measurements or L3 measurements on the first set of (antenna) beams using the beam configuration received at 502. Based on the L3 measurements results, e.g., the strongest results for the RSRP, RSRQ, and/or SINR, the UE may determine a beam of the first set of beams as a Rx beam and use that as a reference beam.

At 508, the UE may use the reference beam and the ephemeris information received at 504, e.g., the first set of ephemeris information and/or the second set of ephemeris information, to identify one or more target Rx beams. The one or more target Rx beams thus may be a subset of the second set of (antenna) beams of the second network device. The second network device may be in a neighboring cell of the UE, which may be being served by the first network device. Accordingly, a cell of the first network device may be referenced herein as a serving cell of the UE. The target Rx beam may be used as a Rx beam at a time T2, while the reference beam may be a Rx beam at a time T1. The time T2 may be later than the time T1. At 510, the UE may report the one or more target Rx beams to the network. By way of a non-limiting example, the UE may also report to the network an SSB index and/or a CSI-RS index corresponding to each of the one or more target Rx beams. Accordingly, the UE may receive DL information via the one or more target Rx beams at the time T2.

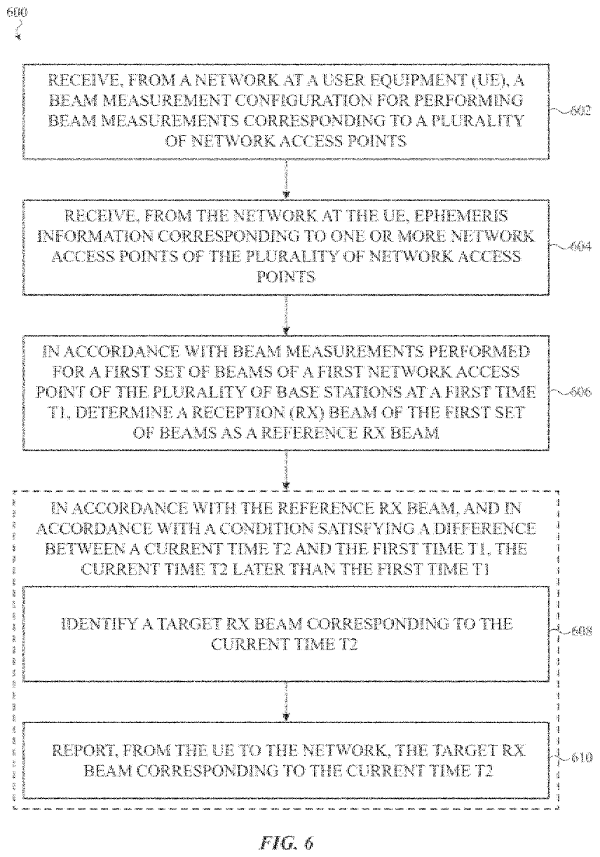

FIG. 6 shows another example method of wireless communication by a UE, which method may be used for reducing beam sweeping time, or for layer-3 (L3) measurement enhancements, as described herein in accordance with some embodiments. As shown in a flow-chart 600, at 602, a UE may receive from a network, a beam measurement configuration for performing beam measurements on a plurality of network devices. Each network device of the plurality of network devices may include a plurality of antenna beams. For example, a first network device of the plurality of network devices may have a first set of (antenna) beams, and a second network device of the plurality of network device may have a second set of (antenna) beams. As described herein, the first network device and/or the second network device may be a network access point, a base station, a relay, a gNodeB, an eNodeB, a gNB, or an eNB, and so on. Further the first network device and/or the second network device may be deployed in a TN and/or a HAPS. A network device deployed in the HAPS may be deployed in a manned or unmanned aerial vehicle, a drone, a satellite orbiting in GSO or N-GSO, and so on. In some embodiments, the first network device and/or the second network device may be operating in the same frequency band or different frequency bands.

In some embodiments, the beam measurement configuration may indicate an SSB and/or a CSI-RS index to be used for performing a beam sweeping procedure or L3 measurements with respect to one or more beams of the first network device and/or the second network device. As described herein, the beam measurement configuration may include an association and/or a mapping of an SSB index for one or more antenna beams of the first network device with a SSB index for one or more antenna beams of the second network device. Similarly, the beam measurement configuration may further include an association and/or a mapping of a CSI-RS index or RS for one or more antenna beams of the first network device with a CSI-RS index or RS for one or more antenna beams of the second network device.

At 604, the UE may receive from the network ephemeris information including values corresponding to various parameters, such as elevation angle information for one or more satellites, orbiting speed of the one or more satellites, trajectory information of the one or more satellites, distance between various satellites, and so on, corresponding to the plurality of network devices.

The ephemeris information may accordingly include a first set of ephemeris information corresponding to the first network device, and/or a second set of ephemeris information corresponding to the second network device.

At 606, the UE may perform beam measurements or L3 measurements on the first set of (antenna) beams using the beam configuration received at 602. Based on the L3 measurements results, e.g., the strongest results for the RSRP, RSRQ, and/or SINR, the UE may determine a beam of the first set of beams as a Rx beam corresponding to time T1 and use that as a reference beam.

The ephemeris information received by the UE at 604 may further include a threshold of time difference which corresponds to a time when the L3 measurements are last performed and a current time. If the time difference between the time when the L3 measurements are last performed and the current time exceeds the threshold of time difference included in the ephemeris information by the network, then the UE may not use the reference beam for determining one or more target Rx beams, as described herein in accordance with some embodiments.

At 608, upon determining that the time when the L3 measurements are last performed and the current time does not exceed the threshold of time difference specified in the ephemeris information, the UE may use the reference beam and the ephemeris information received at 604, e.g., the first set of ephemeris information and/or the second set of ephemeris information, identify one or more target Rx beams. The one or more target Rx beams thus may be a subset of the second set of (antenna) beams of the second network device. The second network device may or may not be in a neighboring cell of the UE, which may be being served by the first network device. Accordingly, a cell of the first network device may be referenced herein as a serving cell of the UE. The target Rx beam may be used as a Rx beam at a time T2, while the reference beam may be a Rx beam at a time T1. The time T2 may be later than the time T1.

By way of a non-limiting example, the one or more target Rx beams may be a subset of the first set of (antenna) beams of the first network device, with respect to a position of the first network device at the time T2. The position of the first network device at the time T2 is different from a position of the first network device at the time T1. The first network device at the time T2 may or may not be in a cell that is different from a cell in which the first network device may be at the time T1.

At 610, the UE may report the one or more target Rx beams to the network. By way of a non-limiting example, the UE may also report to the network an SSB index and/or a CSI-RS index corresponding to each of the one or more target Rx beams. Accordingly, the UE may receive DL information via the one or more target Rx beams at the time T2. In some embodiments, and by way of a non-limiting example, the reference Rx beam and a target Rx beam each may be associated with a different frequency range or a different carrier frequency.

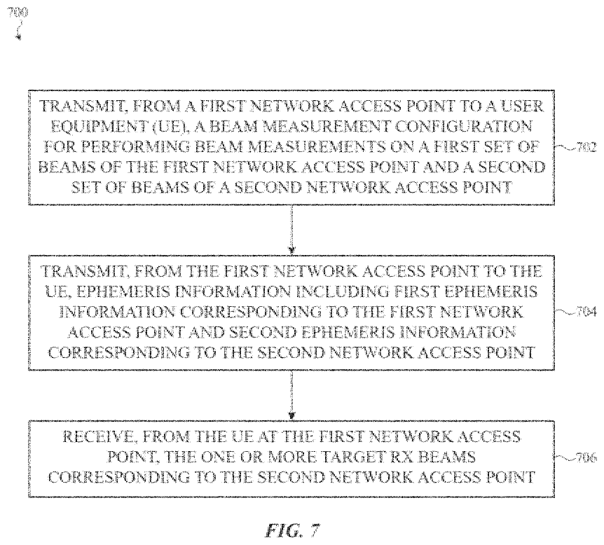

FIG. 7 shows an example method of wireless communication by a network device, which method may be used for reducing beam sweeping time, or for layer-3 (L3) measurement enhancements, as described herein in accordance with some embodiments. As shown in a flow-chart 700, at 702, a network device may transmit to a UE a beam measurement configuration for performing beam measurements on a plurality of network devices including the network device. Each network device of the plurality of network devices may include a plurality of antenna beams. For example, a first network device of the plurality of network devices may have a first set of (antenna) beams, and a second network device of the plurality of network devices may have a second set of (antenna) beams. As described herein, the first network device and/or the second network device may be a network access point, a base station, a relay, a gNodeB, an eNodeB, a gNB, or an eNB, and so on. Further the first network device and/or the second network device may be deployed in a TN and/or a HAPS. A network device deployed in the HAPS may be deployed in a manned or unmanned aerial vehicle, a drone, a satellite orbiting in GSO or N-GSO, and so on. In some embodiments, the first network device and/or the second network device may be operating in the same frequency band or different frequency bands.

In some embodiments, the beam measurement configuration may indicate an SSB and/or a CSI-RS index to be used for performing beam sweeping procedure or L3 measurements with respect to one or more beams of the first network device and/or the second network device. As described herein, the beam measurement configuration may include an association and/or a mapping of an SSB index for one or more antenna beams of the first network device with an SSB index for one or more antenna beams of the second network device. Similarly, the beam measurement configuration may further include an association and/or a mapping of a CSI-RS index or RS for one or more antenna beams of the first network device with a CSI-RS index or RS for one or more antenna beams of the second network device.

At 704, the network device may transmit to the UE ephemeris information including values corresponding to various parameters, such as elevation angle information for one or more satellites, orbiting speed of the one or more satellites, trajectory information of the one or more satellites, distance between various satellites, and so on, corresponding to the plurality of network devices. The ephemeris information may accordingly include a first set of ephemeris information corresponding to the network device, and/or a second set of ephemeris information corresponding to another network device of the plurality of network devices.

In some embodiments, and by way of a non-limiting example, the ephemeris information transmitted to the UE may further include a threshold of time difference which corresponds to a time when the L3 measurements are last performed by the UE and a current time. As described herein, if a time difference between the time when the L3 measurements are last performed and the current time exceeds the threshold of time difference included in the ephemeris information, then the UE may be required to not use the reference beam for determining one or more target Rx beams, as described herein in accordance with some embodiments.

At 706, the network device may receive from the UE the one or more target Rx beams corresponding to the other network device of the plurality of network devices.

Embodiments contemplated herein include an apparatus having means to perform one or more elements of the method 500, 600, or 700. In the context of method 500 or 600, the apparatus may be, for example, an apparatus of a UE (such as a wireless device 902 that is a UE, as described herein). In the context of method 700, the apparatus may be, for example, a network device, which may be a network access point or a base station (such as a network device 920 that is a base station, as described herein).

Embodiments contemplated herein include one or more non-transitory computer-readable media storing instructions to cause an electronic device, upon execution of the instructions by one or more processors of the electronic device, to perform one or more elements of the method 500, 600, or 700. In the context of method 500 or 600, the non-transitory computer-readable media may be, for example, a memory of a UE (such as a memory 906 of a wireless device 902 that is a UE, as described herein). In the context of method 700, the non-transitory computer-readable media may be, for example, a memory of a network device (such as a memory 924 of a network device 920 that is a base station, as described herein).

Embodiments contemplated herein include an apparatus having logic, modules, or circuitry to perform one or more elements of the method 500, 600, or 700. In the context of method 500 or 600, the apparatus may be, for example, an apparatus of a UE (such as a wireless device 902 that is a UE, as described herein). In the context of method 700, the apparatus may be, for example, an apparatus of a network device, which may be a base station or a network access point (such as a network device 920 that is a base station, as described herein).

Embodiments contemplated herein include an apparatus having one or more processors and one or more computer-readable media, using or storing instructions that, when executed by the one or more processors, cause the one or more processors to perform one or more elements of the method 500, 600, or 700. In the context of method 500 or 600, the apparatus may be, for example, an apparatus of a UE (such as a wireless device 902 that is a UE, as described herein). In the context of the method 700, the apparatus may be, for example, an apparatus of a network device, which may be a network access point or a base station (such as a network device 920 that is a base station, as described herein).

Embodiments contemplated herein include a signal as described in or related to one or more elements of the method 500, 600, or 700.

Embodiments contemplated herein include a computer program or computer program product having instructions, wherein execution of the program by a processor causes the processor to carry out one or more elements of the method 500, 600, or 700. In the context of method 500 or 600, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 700, the processor may be a processor of a network device, which may be a network access point or a base station (such as a processor(s) 922 of a network device 920 that is a base station, as described herein), and the instructions may be, for example, located in the processor and/or on a memory of the network device (such as a memory 924 of the network device 920 that is a base station, as described herein).

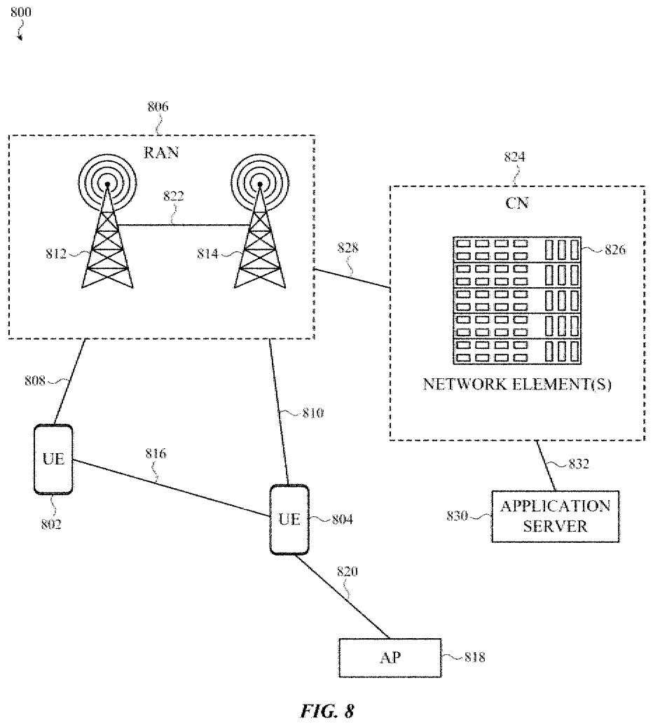

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks) but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, NTN, enhanced NTN (eNTN), etc. The UE 802 and UE 804 utilize connections (or channels) (shown as connection 808 and connection 810, respectively) with the RAN 806, each of which comprises a physical communications interface. The RAN 806 can include one or more network devices, such as network access points or base stations. Base stations 812 and 814 enable the connection 808 and connection 810.

In this example, the connection 808 and connection 810 are air interfaces to enable such communicative coupling and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

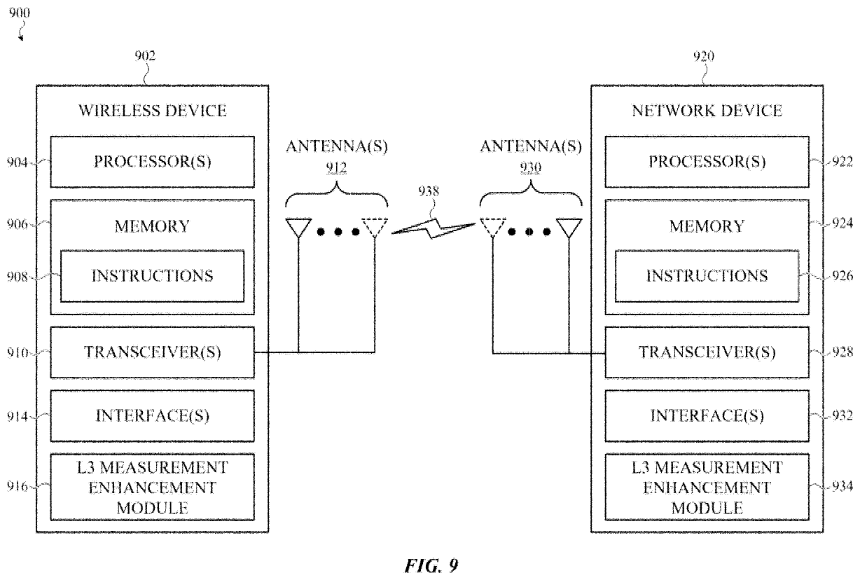

FIG. 9 illustrates a system 900 for performing signaling 938 between a wireless device 902 and a network device 920, according to embodiments disclosed herein. The system 900 may be a portion of a wireless communication system as herein described. The wireless device 902 may be, for example, a UE of a wireless communication system. The network device 920 may be, for example, a base station (e.g., an eNB or a gNB) of a wireless communication system. In some embodiments, the network device 920 may be a network access point and/or a relay. The network device 920 may be deployed in a TN, a high-altitude platform system (HAPS) or a satellite. The HAPS may be a manned or an unmanned aerial vehicle, or a drone. The satellite may be orbiting in a geo synchronous orbit (GSO) or a non-geo synchronous orbit (N-GSO), and therefore in an NTN or eNTN.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include one or more L3 measurement enhancement module(s) 916. The L3 measurement enhancement module(s) 916 may be implemented via hardware, software, or combinations thereof. For example, the L3 measurement enhancement module(s) 916 may be implemented as a processor, circuit, and/or instructions 908 stored in the memory 906 and executed by the processor(s) 904. In some examples, the L3 measurement enhancement module(s) 916 may be integrated within the processor(s) 904 and/or the transceiver(s) 910. For example, the L3 measurement enhancement module(s) 916 may be implemented by a combination of software components (e.g., executed by a DSP or a general processor) and hardware components (e.g., logic gates and circuitry) within the processor(s) 904 or the transceiver(s) 910.

The L3 measurement enhancement module(s) 916 may be used for various aspects of the present disclosure, for example, aspects of FIGS. 1-7, from a UE perspective.

The network device 920 may include one or more processor(s) 922. The processor(s) 922 may execute instructions such that various operations of the network device 920 are performed, as described herein. The processor(s) 904 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include one or more L3 measurement configuration module(s) 934. The L3 measurement configuration module(s) 934 may be implemented via hardware, software, or combinations thereof. For example, the L3 measurement configuration module(s) 934 may be implemented as a processor, circuit, and/or instructions 926 stored in the memory 924 and executed by the processor(s) 922. In some examples, the L3 measurement configuration module(s) 934 may be integrated within the processor(s) 922 and/or the transceiver(s) 928. For example, the L3 measurement configuration module(s) 934 may be implemented by a combination of software components (e.g., executed by a DSP or a general processor) and hardware components (e.g., logic gates and circuitry) within the processor(s) 922 or the transceiver(s) 928.

The L3 measurement configuration module(s) 934 may be used for various aspects of the present disclosure, for example, aspects of FIGS. 1-7 from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive, from a network, a beam measurement configuration for performing beam measurements on a first set of beams of a first network access point in a non-terrestrial network (NTN) and a second set of beams of a second network access point in the NTN;
receive, from the network, ephemeris information including first ephemeris information corresponding to the first network access point and second ephemeris information corresponding to the second network access point in the NTN;
in accordance with the beam measurements performed for the first set of beams, identify a reception (Rx) beam of the first set of beams as a reference beam;
based on the reference beam, and based on the first ephemeris information or the second ephemeris information, identify one or more target Rx beams, the one or more target Rx beams are a subset of the second set of beams; and
generate, for transmission to the network, the one or more target Rx beams to receive downlink information via the second network access point.

2. The apparatus of claim 1, wherein:
the first network access point is a serving network access point, at a first time T1, in a first satellite orbiting in a non-geo synchronous orbit (Non-GSO); and
at the first time T1, the second network access point is a target network access point that is in a second satellite orbiting in the Non-GSO.

3. The apparatus of claim 2, wherein the serving network access point or the target network access point is operating in a frequency band that is above a 10 GHz frequency band.

4. The apparatus of claim 2, wherein the serving network access point is in a first cell, and the target network access point is in a second cell that is a neighboring cell of the first cell.

5. The apparatus of claim 2, wherein the target network access point is indicated based on:
a current serving network access point; and
an elevation angle difference included in the first ephemeris information and corresponding to the current serving network access point.

6. The apparatus of claim 2, wherein the reference beam or the Rx beam of the first set of beams is determined based on the beam measurements corresponding to a reference signal received power (RSRP) measurement, a reference signal received quality (RSRQ) measurement, or a signal-to-interference-plus-noise ratio (SINR) measurement for the serving network access point.

7. The apparatus of claim 6, wherein the beam measurements corresponding to the RSRP measurement, the RSRQ measurement, or the SINR measurement for the serving network access point are determined for a particular synchronization signal block (SSB) index or a particular channel state information reference signal (CSI-RS) index of the reference beam or the Rx beam of the first set of beams.

8. The apparatus of claim 7, wherein the processor is configured to:
receive, from the network, an association between the SSB index or the particular CSI-RS index of the reference beam or the Rx beam of the first set of beams and an SSB index or a CSI-RS index of the one or more target Rx beams; and
derive or determine the SSB index or the CSI-RS index of the one or more target Rx beams corresponding to the SSB index or the particular CSI-RS index of the reference beam or the Rx beam of the first set of beams.

9. An apparatus comprising memory coupled to a processor, the processor configured to:
receive, from a network, a beam measurement configuration for performing beam measurements corresponding to a plurality of network access points deployed in a non-terrestrial network (NTN);
receive, from the network, ephemeris information corresponding to one or more network access points of the plurality of network access points deployed in the NTN;
in accordance with beam measurements performed for a first set of beams of a first network access point of the plurality of network access points at a first time T1, determine a reception (Rx) beam of the first set of beams as a reference Rx beam; and
in accordance with the reference Rx beam, and in accordance with a condition satisfying a difference between a current time T2 and the first time T1, the current time T2 later than the first time T1,
identify a target Rx beam corresponding to the current time T2, the target Rx beam is a beam of a second set of beams of a second network access point of the plurality of network access points or a beam of the first set of beams of the first network access point; and
generate, for transmission to the network, the target Rx beam to receive downlink information beginning at the current time T2.

10. The apparatus of claim 9, wherein:
the first network access point is a serving network access point or a first target network access point, at the first time T1, in a first satellite orbiting in a non-geo synchronous orbit (Non-GSO); and
the second network access point is a second target network access point, at the current time T2, in a second satellite orbiting in the Non-GSO.

11. The apparatus of claim 9, wherein:
the first network access point is operating in a first frequency band that is above a 10 GHz frequency band; and
the second network access point is operating in a second frequency band that is above the 10 GHz frequency band.

12. The apparatus of claim 9, wherein the reference Rx beam and the target Rx beam are associated with different carrier frequencies.

13. The apparatus of claim 9, wherein the first network access point is in a first cell, and the second network access point is in a second cell, the second cell is or is not a neighboring cell of the first cell.

14. The apparatus of claim 9, wherein the processor is configured to,
in accordance with the difference between the current time T2 and the first T1 exceeding a threshold included in the ephemeris information, ignore the Rx beam of the first set of beams to use as the reference Rx beam for determining the target Rx beam of the second set of beams of the second network access point.

15. The apparatus of claim 9, wherein the reference Rx beam is determined based on the beam measurements corresponding to a reference signal received power (RSRP) measurement, a reference signal received quality (RSRQ) measurement, or a signal-to-interference-plus-noise ratio (SINR) measurement performed for the first network access point.

16. The apparatus of claim 15, wherein the beam measurements corresponding to the RSRP measurement, the RSRQ measurement, or the SINR measurement for the first network access point are performed for a particular synchronization signal block (SSB) index or a particular channel state information reference signal (CSI-RS) index of the reference Rx beam of the first set of beams.

17. The apparatus of claim 16, wherein the reference Rx beam and the target Rx beam are associated with different synchronization signal block (SSB) indexes, and the ephemeris information includes a mapping between an SSB index of a beam of the first set of beams and an SSB index of a beam of the second set of beams.

18. A method, comprising:
receiving a beam measurement configuration for performing beam measurements on a first set of beams of a first network access point and a second set of beams of a second network access point, and ephemeris information corresponding to the first network access point or the second network access point;
in accordance with the beam measurements performed for the first set of beams, identifying a reference reception (Rx) beam of the first set of beams;
identifying one or more target Rx beams corresponding to the reference Rx beam, the one or more target Rx beams are a subset of the second set of beams; and
generating, for transmission to the network, the one or more target Rx beams to receive downlink information via the second network access point.

19. The method of claim 18, wherein the one or more target Rx beams include fewer than eight beams.

20. The method of claim 18, wherein the first network access point is deployed in a terrestrial network (TN) or a non-terrestrial network (NTN), and the second network access point is deployed in the TN or the NTN.
